(19) United States
(12) Patent Application Publication
(10) Pub. No.: US 2008/0295353 A1
(43) Pub. Date: Dec. 4, 2008

(54) Container washing and centrifugal drying unit, and container washing and centrifugal drying method

(75) Inventor: Makoto Ogawa, Yokkaichi (JP)

Correspondence Address: RADER FISHMAN & GRAUER PLLC, LION BUILDING, 1233 20TH STREET N.W., SUITE 501, WASHINGTON, DC, 20036, US

(73) Assignee: MISUZU KOKI COMPANY LIMITED, Yokkaichi-shi (JP)

(21) Appl. No.: 12/081,522

(22) Filed: Apr. 17, 2008

(30) Foreign Application Priority Data
Jun. 4, 2007 (JP) 2007-148141

(51) Int. Cl. F26B 19/00; F26B 5/08; F26B 7/00; B08B 7/04; F26B 11/00

(52) U.S. Cl. 34/312; 34/60; 34/58; 34/381; 134/18; 134/115 R

(57) ABSTRACT

In a factory that uses a large number of containers, it is necessary to ensure an installation location for a container washing device that is absolutely necessary as a preprocess for a container drying device.

A container washing and centrifugal drying device has an exterior section having a door section, and having a container washing and centrifugal drying unit that comprises a turntable on which tacked containers are placed inside the exterior section, each of two columns erected at opposing position the same distance from the rotational center of the turntable on an upper part of the turntable, a clamp opening and closing cylinder for opening and closing clamp sections, and a plurality of washing tubes provided in a vertical direction at substantially equal intervals in a circumferential direction on the outer periphery spaced apart from the turntable, each of the washing tubes being provided with a plurality of washing nozzles at equal intervals in the vertical direction facing inwards.

### BACKGROUND OF THE INVENTION

1. Field of the Invention

The present invention relates to a container washing and drying device for washing a container as well as drying by centrifugal rotation, and in detail relates to a container washing and centrifugal drying device and container washing and

centrifugal drying method for a food container or the like used in a foodstuff factory etc. such as a bakery.

2. Description of the Related Art

A food container used in a foodstuff factory such as a bakery is also called a distribution container, or container, and is formed using a hard synthetic resin or the like. This type of container is used repeatedly, and so washing and drying processes are required.

However, conventionally, a container washing unit has been provided separately to a container drying unit, with containers that have been washed in the container washing unit being stacked for conveyance, fed to a container drying unit, and dried.

As a centrifugal container drying unit for drying a container by causing rotation, there have been proposed, by the present applicant, “a container drying unit (Japanese Published utility model application No. Sho. 56-114395) comprising a cylindrical rotating body, internally contacting a container, that is freely opened and closed to split vertically at an appropriate part of a peripheral surface, opening and closing means for opening and closing the cylindrical rotating body, and latching means for restraining the cylindrical rotating body at an upper and lower surface”, and a “centrifugal container drying unit (Japanese Examined utility model application publication No. Sho. 61-20471) characterized by a plurality of rotating tubes appropriately arranged on a rotating disk on which stacked containers are placed, clamps for gripping corners of the stacked containers being fixed by a fixing link to the rotating tubes, and raised up by means of a cam follower fixed to an elevator frame that is raised and lowered, and connected by means of a connecting link having a linking plate linking a rotatable swash plate and rotating tubes, and a curved section”.

The present applicant has also disclosed, as a centrifugal container drying unit, a centrifugal container drying unit (U.S. Pat. No. 6,341,431=Japanese Patent No. 3839220) comprising a turntable on which stacked containers after having been washed are placed, a push/pull rod, mounted in a vertical direction at the rotational center of the turntable and passing through an upper axial center portion, a rotary coupling, linked to the push/pull rod, for transmitting only thrust of a clamp opening and closing cylinder to the push/pull rod without transmitting rotation of a drive motor, each of two columns rising up at opposed positions at an upper portion of the turntable at the same distance from the rotational center of the turntable, an upper plate for respectively connecting each of the two columns at upper portions, two clamp opening and closing yokes provided in a gantry shape together with a section provided in a vertical direction between each of the two opposing columns and a section provided horizontally on the upper plate and being raised and lowered by operation of the rotary coupling, a plurality of connecting rods, which are link mechanisms, provided above and below the respective clamp opening and closing yokes, and provided to the left and right of the respective clamp opening and closing yokes, clamp arms to which the respective connecting rods are connected, four clamp sections to which the respective clamp arms are connected, provided rotatably on the columns, for fixing four corner sections so as to be openable and closable while centering stacked containers, a drive motor for rotatably driving the turntable, the columns, the upper plate and the clamp sections, and a clamp opening and closing cylinder arranged in a vertical direction of the turntable rotational center, wherein the clamp opening and closing cylinder is connected to the clamp opening and closing yokes by means of the push/pull rods and the rotary coupling, and the respective clamp opening and closing yokes open and close the clamp sections by means of the connecting rods, being link mechanisms, and the clamp arm, and wherein at least the columns and the clamp sections are constituted by a carbon composite material”.
Related Art 1: Japanese Published utility model application No. Sho. 56-114395
Related Art 2: Japanese Examined utility model application publication No. Sho. 61-20471
Related Art 3: U.S. Pat. No. 6,341,431=Japanese patent No. 3839220

Conventionally, a container washing unit is provided as a separate unit for processing before the container drying unit, and there is a problem that it is necessary to ensure an installation location for the container washing unit.

Also, besides the equipment costs for a separate unit, there is a problem that it is also necessary to carry out various operations such as maintenance and inspection.

### SUMMARY OF THE INVENTION

In order to solve the above described problems, there is proposed a container cleaning and centrifugal drying device comprising a turntable, with an exterior section having a door section, on which containers that are stacked inside the exterior section are placed, columns erected two at a time at opposed positions at an upper part of the turntable the same distance from the rotational center of the turntable, an upper plate connecting the two opposed columns at upper sections, four clamp sections four corner sections that can be freely opened and closed are fixed while centering the stacked containers, a drive motor for rotatably driving the turntable, the columns, the upper plate and the clamp sections, and a clamp opening and closing cylinder, arranged vertically on the rotational center of the turntable, for opening and closing the clamp section,

and having a container washing and centrifugal drying unit, with a plurality of washing tubes erected in a vertical direction at substantially equal intervals in a circumferential direction on an outer periphery being spaced from the turntable, with respective washing tubes being provided with a plurality of washing nozzles at substantially equal intervals in the vertical direction, facing an inner side.

There is also proposed a container washing and centrifugal drying device comprising a turntable, with an exterior section having a door section, on which containers that are stacked inside the exterior section are placed, columns erected two at a time at opposed positions at an upper part of the turntable the same distance from the rotational center of the turntable, an upper plate respectively connecting two opposed columns at upper sections, two clamp opening and closing yokes provided in a gantry shape together with a section provided in a vertical direction between the two opposing columns and a section provided horizontally on the upper plate and being raised and lowered by operation of a rotary coupling, a plurality of connecting rods, which are link mechanisms provided above and below the respective clamp opening and closing yokes, and provided to the left and right of the respective clamp opening and closing yokes, clamp arms to which the respective connecting rods are connected, four clamp sections to which the respective clamp arms are connected, provided rotatably on the columns, for fixing four corner sections so as to be freely opened and closed while centering stacked containers, a drive motor for rotatably driving the turntable, the columns, the upper plate and the clamp sections, and a clamp opening and closing cylinder arranged in a vertical direction on the turntable rotational center, wherein

the clamp opening and closing cylinder is connected to the clamp opening and closing yokes by means of push/pull rods and the rotary coupling, and the respective clamp opening and closing yokes open and close the clamp sections by means of the connecting rods, being link mechanisms, and a clamp arm,

and having a container washing and centrifugal drying unit, with a plurality of washing pipes erected in a vertical direction at substantially equal intervals in a circumferential direction on an outer periphery being spaced from the turntable, with respective washing tubes being provided with a plurality of washing nozzles at substantially equal intervals in the vertical direction, facing an inner side.

There is further proposed a container washing and centrifugal drying method, in which, after putting stacked containers in a stacked array in a container washing and centrifugal drying unit, containers are conveyed from a door section that has been opened to the inside of an exterior section by a container supply and discharging unit for supply conveyance of the containers, and the door section is placed in a sealed state at the same time as placing the containers on the rotational center of the turntable,

and then, after primary washing where washing water is sprayed to stacked containers using washing water from a washing nozzle of a washing tube before clamping by a clamp section,

all of the stacked containers are clamped by the clamp section,

followed by secondary or second and third washing using washing water from the washing nozzles of the washing tube while rotating the turntable at low speed, and then, after stopping washing water and stopping washing,

the turntable is rotated at high speed to effect centrifugal drying, followed by stopping the turntable, and releasing the clamping by the clamp section, and

the door of the exterior section is opened and stacked containers are discharged to the outside of the exterior section by the container supply and discharging unit.

According to the present invention, since a washing device is incorporated into a container drying device, it is possible to reduce installation costs due to the fact that a container washing device is not needed during processing, and there is also the advantage that it is easy to carry out factory layout etc. because there is no longer any need to ensure a location for installing the container washing device.

### BRIEF DESCRIPTION OF THE DRAWINGS

FIG. 1 is an overall internal front elevation explanatory drawing of a container washing and centrifugal drying device representing an embodiment of the present invention.

FIG. 2 is an overall internal side elevation explanatory drawing of a container washing and centrifugal drying device.

FIG. 3 is an overall internal plan view explanatory drawing of a container washing and centrifugal drying device.

FIG. 4 is an overall front view of a container washing and centrifugal drying device.

FIG. 5 is an overall side view of a container washing and centrifugal drying device.

FIG. 6 is an overall plan view of a container washing and centrifugal drying device.

FIG. 7 is a partially cutaway internal explanatory drawing of a container washing and centrifugal drying device representing an embodiment of the present invention.

FIG. 8 is a flowchart of a washing system of a container washing and centrifugal drying device representing an embodiment of the present invention.

### DESCRIPTION OF THE PREFERRED EMBODIMENTS

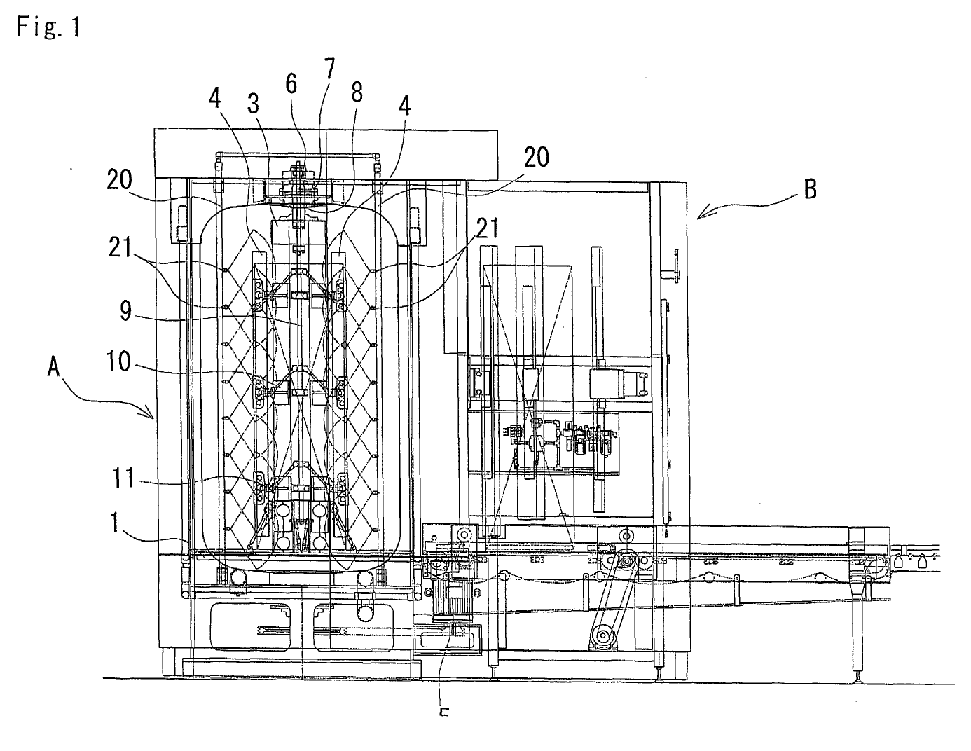

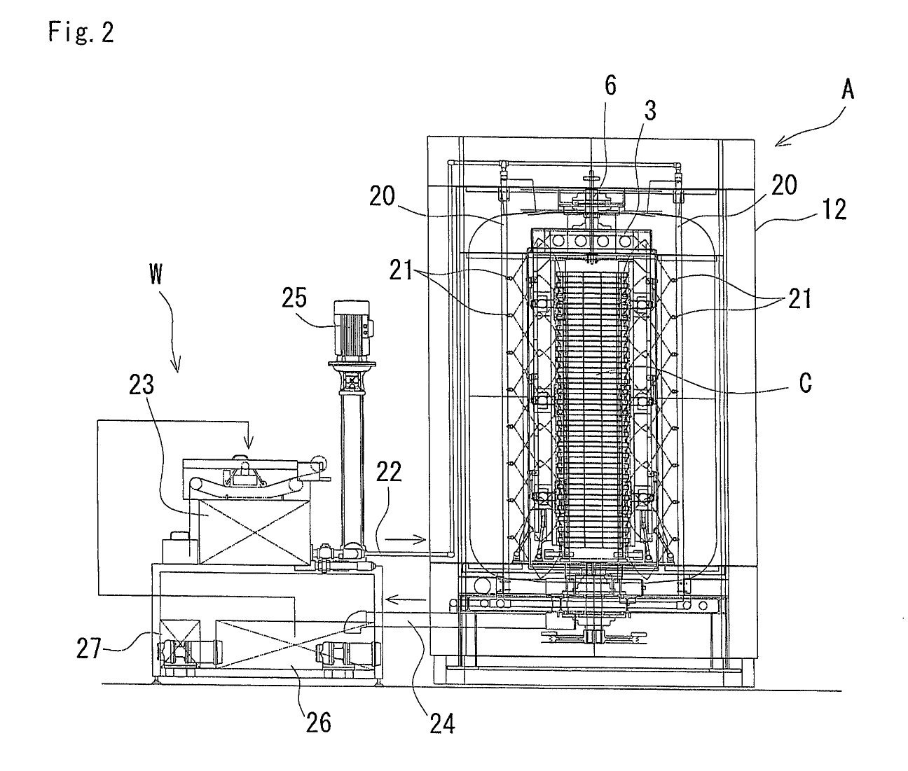

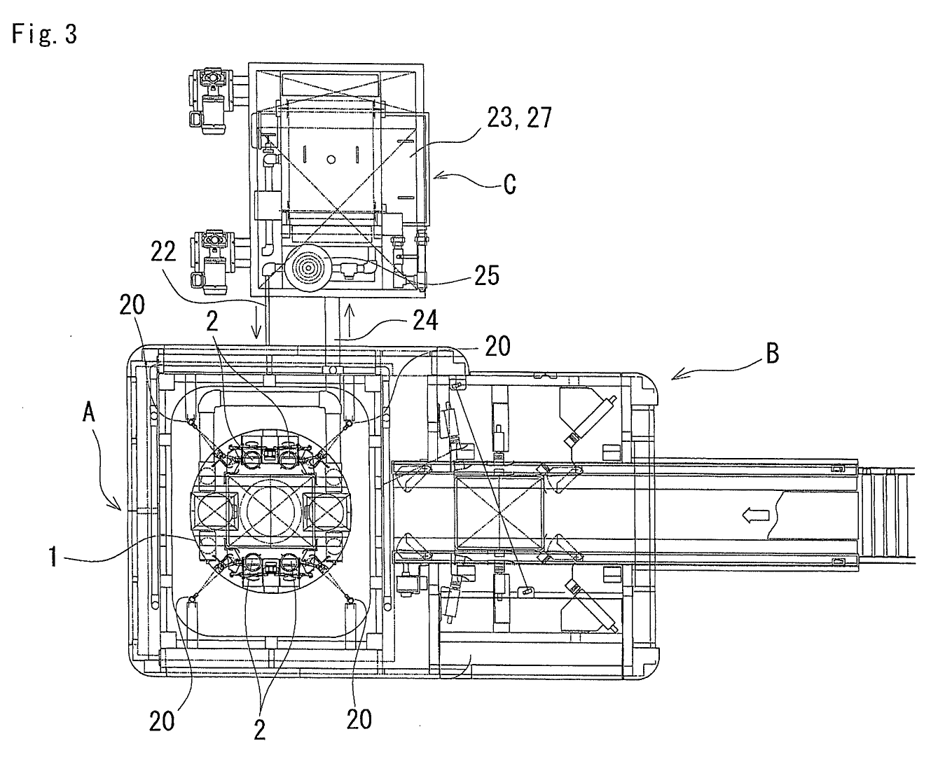

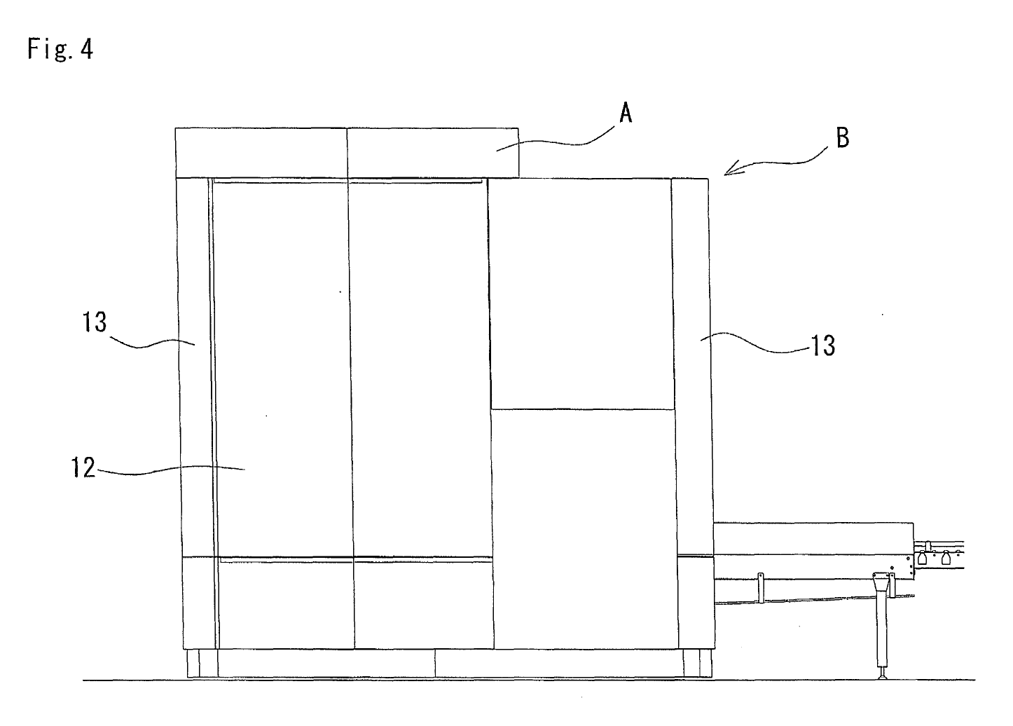

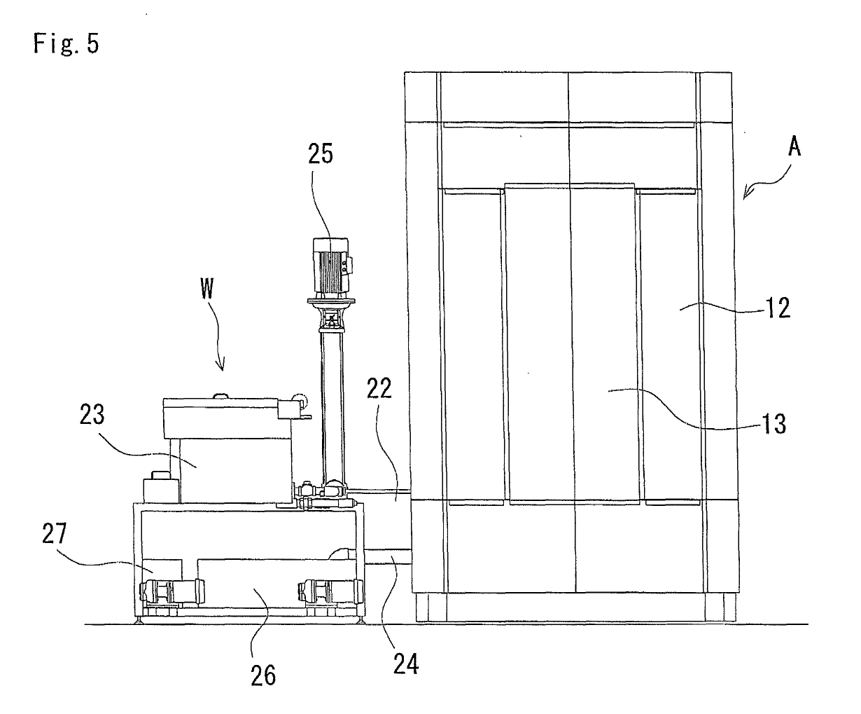

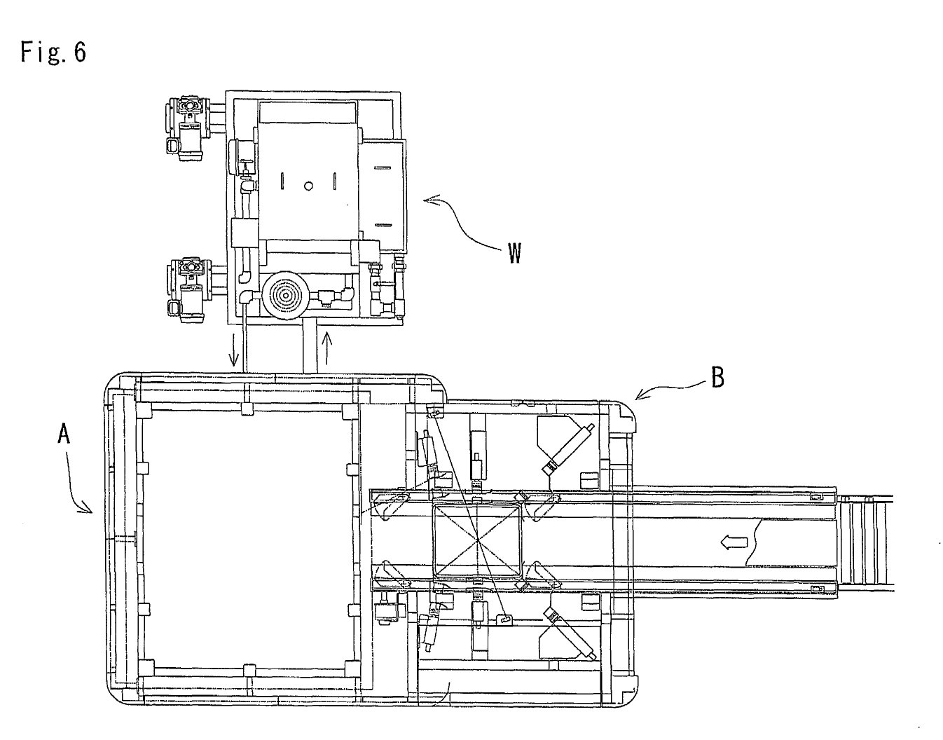

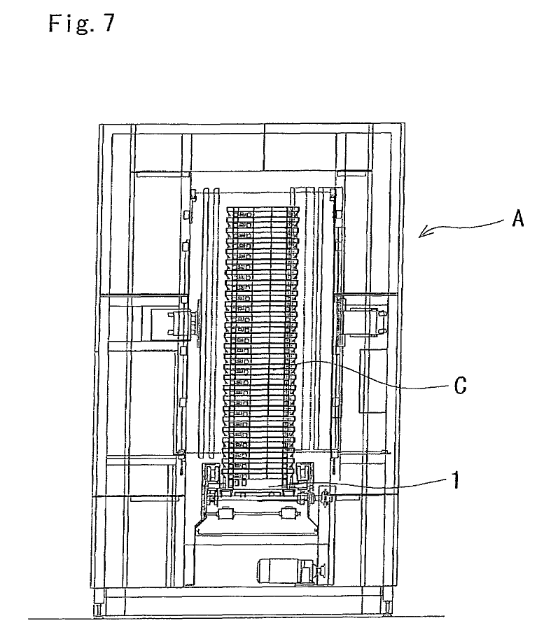

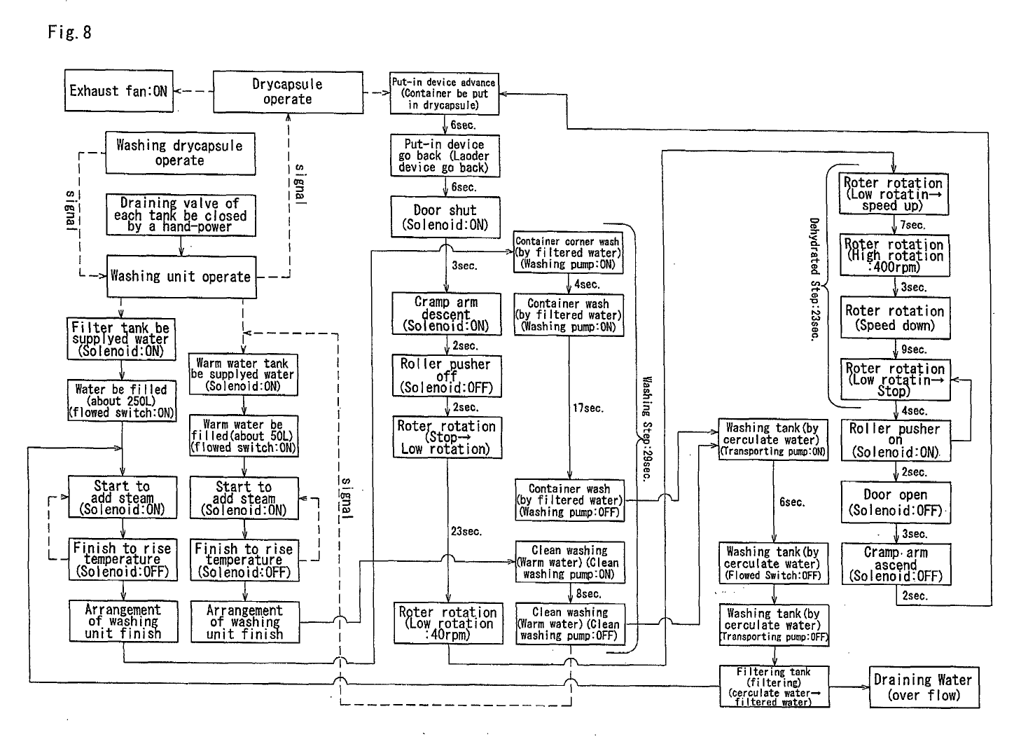

Description will be given based on FIG. 1, which is an overall internal front elevation explanatory drawing of a container washing and centrifugal drying device representing an embodiment of the present invention, FIG. 2 which is an overall internal side elevation explanatory drawing of a container washing and centrifugal drying device, FIG. 3 which is an overall internal plan view explanatory drawing of a container washing and centrifugal drying device, FIG. 4 which is an overall front view of a container washing and centrifugal drying device, FIG. 5 which is an overall side view of a container washing and centrifugal drying device, FIG. 6 which is an overall plan view of a container washing and centrifugal drying device, FIG. 7 which is a partially cutaway internal explanatory drawing of a container washing and centrifugal drying device representing an embodiment of the present invention, and FIG. 8 which is a flowchart of a washing system of a container washing and centrifugal drying device representing an embodiment of the present invention.

The container washing and centrifugal drying device of this invention is comprised of a container washing and centrifugal drying unit A for rotating and centrifugally drying stacked containers C, a container supply and discharging unit B for feeding and discharging stacked containers C to the container washing and centrifugal drying unit A, and a washing unit W for feeding and collecting washing water to the container washing and centrifugal drying unit A, and filtering water after washing.

A plurality of containers C are appropriately stacked, and conveyed as far as an alignment unit by an upstream side supply conveyor. Stacked containers C that have been conveyed are aligned by the alignment unit 12. Stacked and aligned containers C are conveyed to the container washing and centrifugal drying unit A by the container supply and discharging unit B.

The container washing and centrifugal drying unit A comprises a stainless steel turntable 1 that is a polygon shape seen in plan view, in this embodiment an octagonal shape when seen in plan view, that is capable of rotation, on which stacked containers B that have been fed in by the container supply and discharging unit B are mounted substantially on the rotational center, a plurality of columns 2 erected at an upper part of the turntable 1, an upper plate 3 joining the plurality of columns 2 at upper portions, clamp sections 4 provided rotatably on the columns 2 for fixing corners of the containers B so as to be freely opened and closed while centering stacked containers B, a drive motor 5 for rotating the turntable 1, the columns 2, the upper plate 3 and the clamp sections 4, a clamp opening and closing cylinder.6 for opening and closing the clamp sections 4, and a plurality of washing tubes 20 erected in the vertical direction at substantially equal intervals in a circumferential direction at an outer periphery spaced apart from the turntable 1, and provided with a plurality of washing nozzles 21 facing inwards at substantially equal intervals in the vertical direction. The container washing and centrifugal drying unit A has a double swing door section 13 that is opened and closed to a supply side and discharge side of the exterior section 12, and the container washing and centrifugal drying unit A is placed in a sealed state by blocking off the double swing door section 13.

The turntable 1 is connected at a lower section to the drive motor 5 by a V belt. The drive motor 5 uses a regenerative braking type inverter and a motor. The clamp sections 4 are formed from four members provided in a vertical direction having internal right-angled sections for clamping the four corners of the stacked containers C, and in this embodiment are respectively connected to three vertical clamp arms 11. Also in this embodiment, the columns 2 are arranged two at a time at positions facing each other at the same distance from the rotational center of the turntable 1.

Of the members of the container washing and centrifugal drying unit A, at least the columns 2 and the clamp sections 4 are formed of carbon composite materials, and even after conveying and washing containers B mounted on the turntable 1 corrosion resistance with respect to all types of detergent, such as remaining alkaline detergent, is strengthened. Also, inner wall surfaces of the container washing and centrifugal drying unit A are surface processed with a gel-coated FRP resin material, and corner sections are formed in a curved shape.

The clamp opening and closing cylinder 6 is arranged in a vertical direction on the rotational center of the turntable 1, and is connected to a plurality of clamp opening and closing yokes 9 provided in the vertical direction between the columns 2 by means of a push pull rod 7 passing through the upper axial center section and a rotary coupling 8 for transmitting only thrust of the clamp opening and closing cylinder 6 without transmitting rotation of the drive motor 5.

The clamp opening and closing yokes 9 are respectively provided in a vertical direction between the plurality of columns 2, and provided in a gantry shape together with sections provided horizontally on the upper plate 3. A plurality of connecting rods 10, three in this embodiment, being link mechanisms, are provided vertically, and to the left and right, of the clamp opening and closing yokes 9 arranged vertically at respectively opposing positions, and the respective connecting rods 10 are connected to respective clamp arms 11. The respective clamp arms 11 are connected to four clamp sections 4 having internal right-angled sections for clamping the four corners of the stacked containers B.

The connecting rods 10 are rotatably connected to the clamp opening and closing yokes 9, and with the clamp sections in a closed state clamping the four corners of the stacked containers B, are in a horizontal state, while in a state where the clamp sections 4 are closed a gap between respective upper sections is narrowed, and a gap between respective lower sections is widened.

The washing tubes 20 in this embodiment are arranged numbering four vertically in a circumferential direction of an outer periphery, having a gap from the turntable 1, with eight washing nozzles 21 being provided in a vertical direction at substantially equal intervals facing inwards.

The four washing tubes 20 are connected at upstream sections to feed water pipes 22 of the washing unit W.

Washing water after washing is caught in a lower section of the container washing and centrifugal drying unit A, and a circulation conduit 24 for supplying this water to a circulation filtrate tank 23 provided in the washing unit W is provided.

The washing unit W comprises a water pipe 22, a washing pump 25, a circulation filtering device 26, a circulation filtrate tank 23, and a clean water tank 27, with the water pipe 22 being selectively connected at an upstream section to the circulation filtrate tank 23 and the clean water tank 27, and at a downstream section to an upstream section (upper end) of the washing pipes 20. The circulation filtrate tank 23 and the clean water tank 27 have a heater and a temperature sensor, and keep internal water at a fixed temperature.

Next, operation of the container washing and centrifugal drying device of this invention will be described. Containers C used with the embodiment of the invention have a rectangular shape in plan view, are appropriately stacked and conveyed as far as an alignment unit 12 by an upstream supply conveyor, and stack aligned by the alignment unit 12. The stacked containers C, once placed in the container washing and centrifugal drying unit A from an end surface side in the longitudinal direction, are placed in a sealed state where the double swing door section 19 provided in the exterior section 12 is closed.

Stacked containers C that have been conveyed into the container washing and centrifugal drying unit A are placed close to the rotational center of the turntable 1. If a startup switch for the container washing and centrifugal drying device is turned on in this state, the container washing and centrifugal drying unit A and washing unit W are both driven in accordance with instruction signals sent to them.

The washing pump 25 of the washing unit W operates in accordance with a command signal, and circulation filtered water passes from the circulation filtration tank 23 through the water pipe 22, and is fed to the four washing tubes 20 at a fixed pressure. Filtrate water that has been fed to the washing tubes 20 is sprayed in an open fan shape from the washing nozzles 21 towards stacked containers C, and in particular, as shown in the drawings, vertically in an open fan shape, to subject the stacked containers to primary washing.

Next, the clamp opening and closing cylinder 6 is operated to lower the push pull rod 7 passing through the upper axial center section, arranged in vertically on the rotational center of the turntable 1. The push pull rod 7 lowers two clamp opening and closing yokes 9 that are provided vertically in a gantry shape, by means of a rotary coupling 8 that transmits only thrust of the clamp opening and closing cylinder 6 without transmitting rotation of the drive motor 5.

If two respectively opposed clamp opening and closing yokes 9 are lowered, left and right connecting rods 10, which have three vertical link mechanisms, are put into a single flat state, by lowering upper end connecting sections in a state where a gap between connecting rods is narrowed at upper sections and a gap between connecting rods is widened at lower sections, and rotating with respect to the clamp opening and closing yokes 9. Respective connecting rods 10 have other end sections connected to respective clamp arms 11, and due to the hyphen-shaped horizontal state of the connecting rods 10 the respective clamp arms 11 rotate four clamp sections 4, four corners of a container C are inserted from outside, and the container C is fixed so that there is no movement at the rotational center of the turntable 1. The clamped state of the container C is at both end surfaces in a shorter side direction, and the upper plate 3 is a comparatively short distance from the rotational center.

At this time, the container C is pressed from an upper section by the push pull rod 7 due to the downward pressure of the clamp opening and closing cylinder 6, and also, because of respectively adjacent connecting rods 10 change the shape to the hyphen-shaped horizontal state, it is possible to reliably resist centrifugal force due to rotation of the container C. As another embodiment, by providing a plurality of connecting rods 10 at multiple levels, a fail safe structure is realized to oppose centrifugal force and increasing safety.

If the containers C are held (gripped) by the clamp sections 4, the drive motor 5 operates, rotational force is transmitted to the turntable 1, and the washing pump 25 of the washing unit W operates in synchronism with low speed rotation of the turntable 1, and circulation filtrate water is again passed through the water pipe 22 by the circulation filtering tank 23 and fed at a fixed pressure to the four washing tubes 20. Circulation filtered water that has been fed to the washing tubes 20 is sprayed in an open fan shape from the washing nozzles 21 towards stacked containers C, and in particular, as shown in the drawings, vertically in an open fan shape, to subject the stacked containers rotating at low speed to second washing. At this time rotational force is not transmitted to the clamp opening and closing cylinder 6 by operation of the rotary coupling, even if the turntable 1 rotates.

After second washing for a fixed time, the supply tank is switched from the circulation filtering tank 23 to the clean water tank 27, and washing water from the clean water tank 27 passes through the water pipe 22 and is fed at a fixed pressure to the four washing tubes 20. Washing water that has been fed to the washing tubes 20 is sprayed in an open fan shape from the washing nozzles 21 towards stacked containers C, and in particular, as shown in the drawings, vertically in an open fan shape, to subject the stacked containers rotating at low speed to third washing.

Further, after a predetermined fixed time, the washing pump 25 is stopped, and feeding of water from the washing unit W is stopped.

Next, after instruction commands to the drive motor 5, or after a previously set time, the rotational speed of the turntable 1 is accelerated up to a specified rotational speed to rotate at high speed. After centrifugal drying (dehydration) of the containers C by rotational centrifugal force the drive motor 5 is stopped at a specified position by rotational braking. At the time of this braking, since the essential members of the container washing and centrifugal drying unit A are made of carbon composite material, they are lightweight compared to the related art, which means that it is possible to significantly reduce a rotational inertia moment. Also, an inner wall surface of the container washing and centrifugal drying unit A is subjected to surface treatment with a gel-coated FRP resin, and corner sections are made curved, which means that it is difficult for waste, dust and water droplets to collect in the corner sections, and the drainage time for water droplets is also fast, which improves sanitary conditions.

The stacked containers after centrifugal drying are discharge to a discharge conveyor by the container supply and discharge unit B opening the double swing door 13 of the exterior section 12.

Next, operation of the washing unit W will be described based on a flow chart of the washing system of the container washing and centrifugal drying device representing the embodiment of this invention.

Stacked containers C are placed close to the rotational center of the turntable 1, and if a startup switch for the container washing and centrifugal drying device is turned on, the container washing and centrifugal drying unit A and washing unit W are both automatically operated in accordance with instruction signals sent to them.

In the washing unit W, the circulation filtering tank (filter tank in the drawings) 23 and the clean water tank (hot water tank in the drawings) 27 hold water that has been heated to a fixed temperature by a temperature regulator, and washing preparation is completed. If the washing pump 25 is then started, in the case of primary washing, circulation filtered water passes from the circulation filtration tank 23 through the water pipe 22, and is fed to the four washing tubes 20 at a fixed pressure. Filtration water that has been used for washing passes by way of a plurality of units that are circulation filtration units (shown in the drawing as a plurality of washing tanks) and returned to the circulation filtration tank through the circulation conduit 24. This circulation filtered water is used in primary washing and second washing.

Third washing is carried out using washing water from the clean water tank 27, and washing water after washing has been carried out, similar to filtration water that has been used for washing, passes by way of a plurality of units that are circulation filtration units (shown in the drawings as a plurality of washing tanks) and filtered water is returned to the circulation filtration tank through the circulation conduit 24. This circulation filtered water is used in primary washing and second washing.

### INDUSTRIAL APPLICABILITY

This invention has high applicability in factories that repeatedly use a large number of containers, and particularly as a device for washing and drying containers such as foodstuff containers used in a food factory such as a bakery.

### Description of the Numerals

A container centrifugal drying unit
1 turntable
2 column
3 upper plate
4 clamp section
5 drive motor
6 clamp opening and closing cylinder
7 push pull rod
8 rotary coupling
9 clamp opening and closing yoke
10 connecting rod
11 clamp arm
12 exterior section
13 double swing door section
20 washing tube
21 washing nozzle
B container supply and discharge unit
W washing unit
22 water pipe
23 circulation filtration tank
24 circulation conduit
25 washing pump
26 circulation filtration unit
27 washing water pump
C container

What is claimed is:

1. A container cleaning and centrifugal drying unit comprising a turntable, with an exterior section having a door section, on which containers that are stacked inside the exterior section are placed, columns erected two at a time at opposed positions at an upper part of the turntable the same distance from the rotational center of the turntable, an upper plate connecting the two opposed columns at upper sections, four clamp sections for fixing four corner sections that can be freely opened and closed while centering the stacked containers, a drive motor for rotatably driving the turntable, the columns, the upper plate and the clamp sections, a clamp opening and closing cylinder, arranged in a vertical direction on the rotational center of the turntable, for opening and closing the clamp sections, and
having a container washing and centrifugal drying unit, with a plurality of washing pipes erected in a vertical direction at substantially equal intervals in a circumferential direction on an outer periphery being spaced from the turntable, with respective washing tubes being provided with a plurality of washing nozzles at substantially equal intervals in the vertical direction, facing an inner side.

2. A container washing and centrifugal drying device comprising a turntable, with an exterior section having a door section, on which containers that are stacked inside the exterior section are placed, columns erected two at a time at opposed positions at an upper part of the turntable the same distance from the rotational center of the turntable, an upper plate respectively connecting two opposed columns at upper sections, two clamp opening and closing yokes provided in a gantry shape together with a section provided in a vertical direction between the two opposing columns and a section provided horizontally on the upper plate and being raised and lowered by operation of a rotary coupling, a plurality of connecting rods, which are link mechanisms provided above and below the respective clamp opening and closing yokes, and provided to the left and right of the respective clamp opening and closing yokes, clamp arms to which the respective connecting rods are connected, four clamp sections to which the respective clamp arms are connected, provided rotatably on the columns, for fixing four corner sections so as to be freely opened and closed while centering stacked containers, a drive motor for rotatably driving the turntable, the columns, the upper plate and the clamp sections, and a clamp opening and closing cylinder arranged in a vertical direction on the turntable rotational center, wherein
the clamp opening and closing cylinder is connected to the clamp opening and closing yokes by means of push pull/rods and the rotary coupling, and the respective clamp opening and closing yokes open and close the clamp sections by means of the connecting rods, being link mechanisms, and a clamp arm,
and having a container washing and centrifugal drying unit, with a plurality of washing pipes erected in a vertical direction at substantially equal intervals in a circumferential direction on an outer periphery being spaced from the turntable, with respective washing tubes being provided with a plurality of washing nozzles at substantially equal intervals in the vertical direction, facing an inner side.

3. A container washing and centrifugal drying method, in which, after aligning stacked containers in a stacked array in a container washing and centrifugal drying unit, containers are conveyed from a door section that has been opened to the inside of an exterior section by a container supply and discharging unit for supply conveyance of the containers, and the door section is placed in a sealed state at the same time as placing the containers on the rotational center of the turntable,
and then, after primary cleaning where cleaning water is sprayed to stacked containers using cleaning water from a cleaning nozzle of a cleaning tube before clamping by a clamp section,
all of the stacked containers are clamped by the clamp section,
followed by second or second and third cleaning using cleaning water from the cleaning nozzles while rotating the turntable at low speed, and then after stopping cleaning water and stopping cleaning,
the turntable is rotated at high speed to effect centrifugal drying, followed by stopping the turntable, and releasing the clamping by the clamp section, and
the door of the exterior section is opened and stacked containers are discharged to the outside of the exterior section by the container supply and discharging unit.
